(19) United States
(12) Patent Application Publication
(10) Pub. No.: US 2008/0244678 A1
(43) Pub. Date: Oct. 2, 2008

(54) Method for transmitting/receiving broadcasting signal and apparatus for receiving broadcasting signal

(76) Inventors: Jin Pil Kim, Seoul (KR); Joon Hui Lee, Seoul (KR)

Correspondence Address: MCKENNA LONG & ALDRIDGE LLP;Song K. Jung, 1900 K Street, N.W., Washington, DC, 20006, US

(21) Appl. No.: 12/076,429

(22) Filed: Mar. 18, 2008

(30) Foreign Application Priority Data
Mar. 26, 2007 (KR) 10-2007-0029164

(51) Int. Cl. H04N 7/173

(52) U.S. Cl. 725/118

(57) ABSTRACT

Disclosed herein are disclosed a method for transmitting/receiving a broadcasting signal and an apparatus for receiving the broadcasting signal. A plurality of video streams may be transmitted through a single virtual channel and an identifier for identifying the plurality of video streams may be included in program table information and the program table information be transmitted/received. Accordingly, it is possible to obtain the plurality of video streams with respect to the single virtual channel.

This application claims the benefit of Korean Patent Application No. 10-2007-0029164, filed on Mar. 26, 2007 which is hereby incorporated by reference as if fully set forth herein.

### BACKGROUND OF THE INVENTION

1. Field of the Invention

The present invention relates to a method for transmitting/receiving a broadcasting signal and an apparatus for receiving the broadcasting signal.

2. Discussion of the Related Art

In a case where a digital broadcasting system transmits a broadcasting signal, a single program may include one video stream, at least one audio stream and a data stream which may be added if necessary. As a technology of compressing a moving image has been developed, excellent codec having a higher compression rate has been introduced. In addition, as the Internet has come into wider use and a signal transmission rate of each network has been increased, an IPTV broadcast for providing a viewer with a variety of contents such as contents on demand (CoD), games or news has been realized, in addition to real-time broadcasts.

A single program may be distinguished by one entity called a virtual channel. Conventionally, if the single program including one video stream is transmitted and a single virtual channel is an image channel, one video stream is transmitted. In addition, an audio stream or a data stream may be included.

### SUMMARY OF THE INVENTION

Accordingly, the present invention is directed to a method for transmitting/receiving a broadcasting signal and an apparatus for receiving the broadcasting signal that substantially obviate one or more problems due to limitations and disadvantages of the related art.

An object of the present invention is to provide a method for transmitting/receiving a broadcasting signal, which is capable of efficiently transmitting video streams, and an apparatus for receiving the broadcasting signal.

Another object of the present invention is to provide a method for transmitting/receiving a broadcasting signal, which is capable of transmitting at least two video streams through a single virtual channel, and an apparatus for receiving the broadcasting signal.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a method for transmitting a broadcasting signal. In this method, program table information including an identifier for identifying a plurality of video streams included in a single virtual channel is generated. In addition, the generated program table information and the plurality of video streams are multiplexed and the multiplexed program table information and video streams are transmitted.

In another aspect of the present invention, there is provided a method for receiving a broadcasting signal. In this method, a broadcasting signal in which a plurality of video streams included in a single virtual channel and program table information including information for identifying the plurality of video streams are multiplexed is received. In addition, the video streams are parsed using the received program table information so as to obtain the video streams, and at least one video stream of the obtained video streams is decoded and outputted.

In another aspect of the present invention, there is provided an apparatus for receiving a broadcasting signal. A receiver receives a broadcasting signal and a demodulator demodulates the received broadcasting signal. A demultiplexer demultiplexes a plurality of video streams included in a single virtual channel and program table information in the broadcasting signal demodulated by the demodulator, and a program table information decoder decodes an identifier for paring the plurality of video streams from the single virtual channel of the broadcasting signal in the program table information demultiplexed by the demultiplexer. In addition, a decoder decodes the plurality of video streams according to the identifier decoded by the program table information decoder, and an output unit outputs the video stream output from the decoder.

The program table information may identify the plurality of video streams in single virtual channel. The virtual channel may have a service type value indicating that the plurality of video streams are included. The program table information may include information indicating that, among the plurality of video streams, a first video stream is a stream configuring a multi-view image of a second video stream or a highlight image of the second video stream.

The program table information may be a program map table (PMT) or a virtual channel table (VCT).

The program table information may parse a supplementary video stream and an audio stream related to the supplementary video stream among the plurality of video streams in a virtual channel.

The program table information may include information indicating which type of a video stream the supplementary video stream of the virtual channel of the video streams is.

The information indicating which type of the video stream the supplementary video stream is may include at least one of information indicating that the supplementary video stream is a stream for a multi-view image of a main video of the single virtual channel, information indicating that the supplementary video stream is a stream for a highlight image of the main video, information indicating that the supplementary video stream is a stream for a commentary image describing the main video, and information indicating that the supplementary video stream is a stream for a finger-language image of the main video

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a view showing an example of a method for transmitting/receiving a broadcasting signal;

FIG. 2 is a schematic view showing service components included in a digital broadcasting signal;

FIG. 3 is a view showing program table information which is multiplexed and transmitted;

FIG. 4 is a view showing an example of transmitting a broadcasting signal according to the ATSC;

FIG. 5 is a view showing program table information when at least two video streams are transmitted through a single virtual channel;

FIG. 6 is a view showing another program table information when at least two video streams are transmitted through the single virtual channel;

FIG. 7 is a view showing a service type according to an ATSC broadcasting system;

FIG. 8 is a view showing a syntax for parsing information about a supplementary video stream when the supplementary video stream is included in the single virtual channel in addition to a main video stream;

FIG. 9 is a view showing detailed information about the supplementary video stream;

FIG. 10 is a view showing another syntax for parsing the information about the supplementary video stream;

FIG. 11 is a view showing an example of an apparatus for receiving a broadcasting signal; and

FIG. 12 is a view showing an example of a demodulator.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

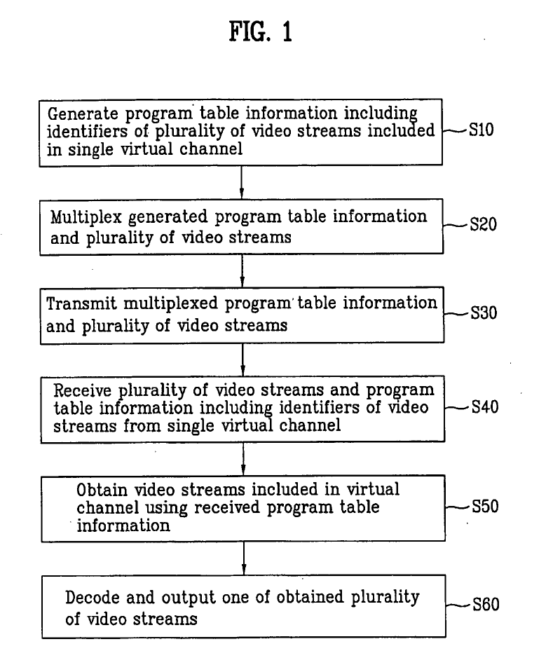

FIG. 1 is a view showing an example of a method for transmitting/receiving a broadcasting signal. The method for transmitting/receiving the broadcasting signal will be described with reference to FIG. 1.

Program table information including identifiers of a plurality of video streams included in a single virtual channel is generated (S10).

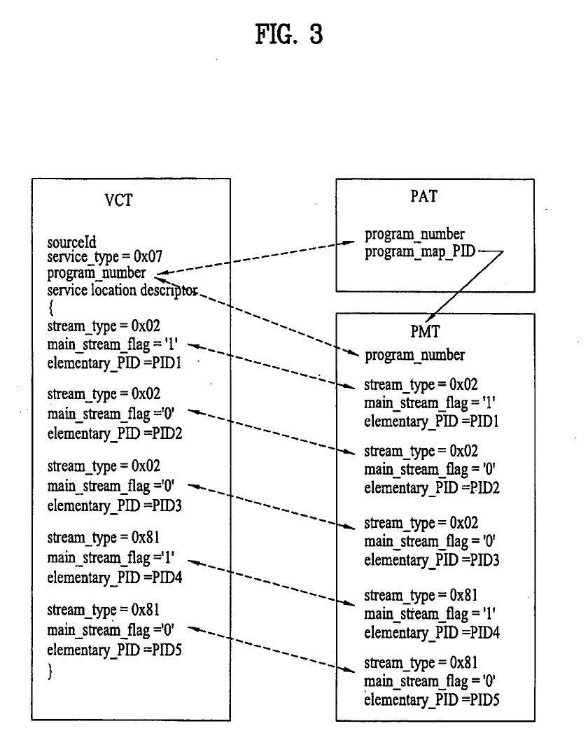

In the present example, at least two video streams can be transmitted through the single virtual channel. For example, if the two video streams are transmitted through the single virtual channel, one stream becomes a main video stream of the virtual channel and the other stream becomes a supplementary video stream. The program table information which can describe the video streams will be disclosed in detail with reference to FIGS. 3 to 10.

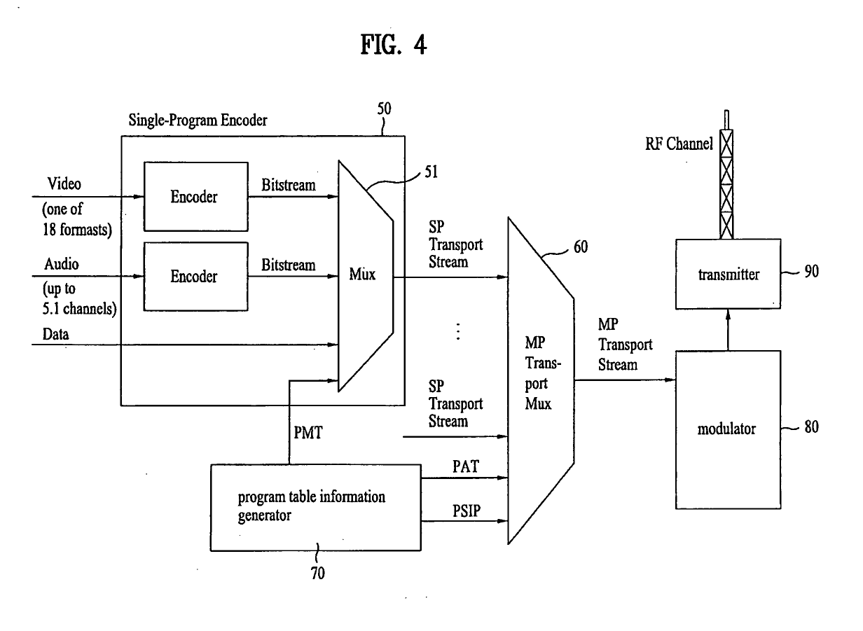

The generated program table information and the plurality of video streams are multiplexed in the single virtual channel (S20). The multiplexing process is shown in FIG. 4.

Then, the multiplexed program table information and video streams are transmitted (S30). Accordingly, the plurality of video streams can be transmitted through the single virtual channel and the identifiers of the plurality of video streams can be included in the program table information.

Now, a process of receiving a broadcasting signal when at least two video streams are transmitted through the single virtual channel will be described.

The plurality of video streams and the program table information including the identifiers of the video streams are received through the single virtual channel (S40). The program table information is shown in FIGS. 3 to 10.

Then, the video streams included in the single virtual channel are obtained using the received program table information (S50).

Then, the obtained video streams are decoded and displayed (S60). The video streams included in the single virtual channel may be multi-view video streams, video streams for highlight images of the main video stream and so on. Accordingly, the multi-view video streams can be stereoscopically displayed or the images of the video streams can be displayed on a screen by a picture-in-picture (PIP).

In order to easily describe FIG. 1, an example of multiplexing service components will be described.

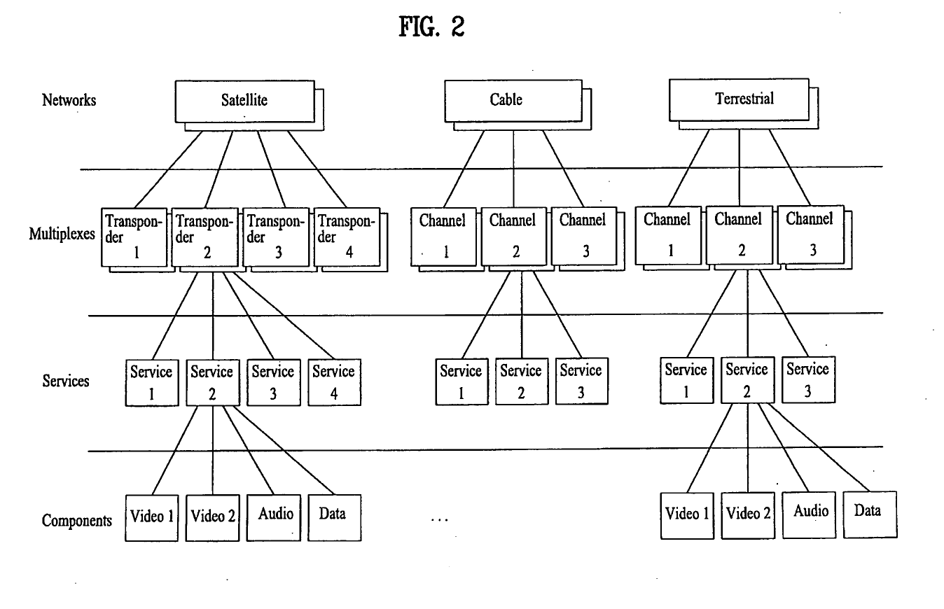

FIG. 2 is a schematic view showing service components included in a digital broadcasting signal. A digital broadcasting signal can be transmitted through a satellite, cable or terrestrial transmission medium. Broadcasting signals transmitted through the transmission medium may be divided according to the frequencies of signals transmitted by a plurality of channels or a plurality of transponders, and the signals transmitted through the channels or the transponders include a plurality of services. One service may include at least one of a video stream, an audio stream and a data stream. Services divided by programs are multiplexed in a channel through which the broadcasting signal is transmitted. The channel for transmitting a single program may be called a virtual channel. In the example of FIG. 1, at least one video stream may be multiplexed and transmitted through the virtual channel for transmitting the video broadcasting signal.

In the present example, the single virtual channel may include at least two video streams. Accordingly, at least two video streams may be transmitted as the single program corresponding to the single virtual channel. That is, at least two video streams which are related to each other may be transmitted as the single program through the single virtual channel.

According to the present embodiment, at least two video streams which are not related to each other in contents may be transmitted through the single virtual channel such that at least one program is transmitted through the single virtual channel.

Alternatively, audio streams having at least two different languages may be transmitted through the single virtual channel. In this case, information about audio streams preferred by the respective virtual channels may be further included and the streams including the information about the audio streams may be transmitted through the respective virtual channels.

The example of FIG. 2 shows an inclusion relation between components if at least two video streams are included in each virtual channel of a satellite broadcast or terrestrial broadcast. Hereinafter, for example, an ATSC broadcast which is the terrestrial broadcast is described.

FIG. 3 is a view showing program table information which is multiplexed and transmitted. As an example of transmitting a broadcasting signal, for example, an ATSC system will be described as an example of the program table information. The program table information includes program specific information (PSI) according to a transmission structure of a moving picture experts group (MPEG) and a program and system information protocol (PSIP) according to transmission structures of broadcasting systems. The PSI according to the transmission structure of the MPEG includes a program association table (PAT), a program map table (PMT) and so on.

The PAT can parse packet identifiers of PMT (program_map_PID) which can parse programs included in a transmission stream. The PMT can parse stream-type and elementary_PID for respective programs according to program_number included in the PAT. The structure of the virtual channel for the programs which can be parsed by the PAT may be identified and described by a virtual channel table (VCT). The VCT can parse the packet identifier (PID) for elementary streams through a service location descriptor (SLD). The elementary stream parsed by the VCT may be matched with the PID parsed by the PMT.

In FIG. 3, a solid line indicates a transport packet for a program element identified by the PID value and a dotted line indicates a field having the same value in the field values of the tables. Program_number of the PAT is an identifier for identifying the programs. The program_number is also included in the PMT and the VCT. The stream PID of the PMT containing the configuration information of the programs is included in the PAT. With respect to the same program_number, stream_type and elementary_PID values of the SLD in the VCT are equal to stream_type and elementary_PID values of the PMT, respectively.

Main_stream_flag included in the VCT and the PMT shown in FIG. 3 is an example of the identifier indicating that a plurality of video streams are included in each virtual channel. As the example of the program table information, an identifier indicating that the plurality of video streams is included in the virtual channel may be included. In FIG. 3, if the main_stream_flag is 0 with respect to the stream type 0x02 of the video stream, it is indicated that the plurality of video streams are included in the virtual channel. Meanwhile, a plurality of audio streams may be included in the single virtual channel. Audio streams having different languages such as a Korean audio stream and an English audio stream may be included and transmitted through the single virtual channel. In this case, the main_stream_flag may indicate the identifier of a preferred audio stream in each virtual channel. For example, if the main_stream_flag is 0, a plurality of audio streams are included in the single virtual channel. An identifier indicating that any one specific audio stream is preferred may be included. An example in which the identifier is included in the VCT or the PMT will be described with reference to FIGS. 5 to 10. Hereinafter, for example, the case where the plurality of video streams are included in the single virtual channel will be described.

FIG. 4 is a view showing an example of transmitting a broadcasting signal according to the ATSC as an example of multiplexing the PSI and the PSIP with the streams and transmitting the multiplexed streams. Data for a video stream, data for an audio stream and data for a data stream are coded and are transmitted to a first multiplexer 51. The program table information according to the PSI and the PSIP, which is generated by a program table information generator, is multiplexed by the first multiplexer 51 and is outputted.

A program encoder 50 can output a stream which is obtained by multiplexing streams of the single program and the program table information which is information about the streams. A second multiplexer 60 can multiplex transport streams forming the programs and the program table information according to the PSIP and can output the multiplexed stream. In the present example, at least two video streams may be included in the single virtual channel. If at least two video streams are included in the single virtual channel, a supplementary video stream can be displayed together with a separate audio stream which is separated from a main video stream, in addition to the main video stream. In this case, the audio stream of the supplementary video stream may be included in the single virtual channel.

A program table information generator 70 can generate information for parsing at least two video streams in the program table information and transmit the program table information including the information. The program table information will be described in detail with reference to FIGS. 5 to 10. A modulator 80 receives the multiplexed program stream, performs channel coding, and modulates the program stream according to an 8-vestigial sideband (VSB) modulation. Then, a transmitter 90 transmits the modulated broadcasting signal through an RF channel.

FIG. 5 is a view showing program table information when at least two video streams are transmitted as a single program. FIG. 5 shows the program table information which may be included in the PMT. The PMT includes a program descriptor and a stream descriptor. The program descriptor can parse the stream_type and the elementary_PID included in any program and the stream descriptor can parse the elementary stream for each stream. In the example of FIG. 5, the main_stream_flag is information indicating whether at least two video streams are included in the single virtual channel. For example, if the main_stream_flag is 1, only one video stream is included in the single program and, if the main_stream_flag is 0, at least two video streams are included in the single program. If the main_stream_flag is 0 (if the supplementary video stream is included in the single virtual channel in addition to the main video stream), the stream descriptor in “for loop” can parse the supplementary video stream.

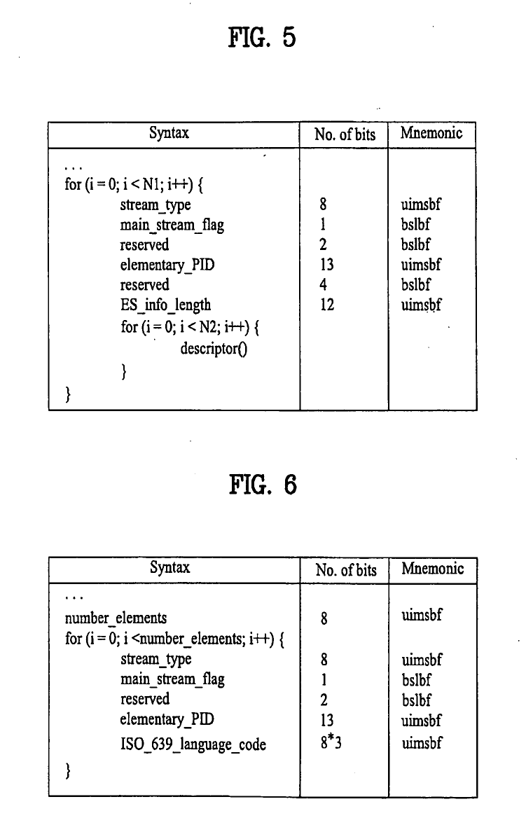

FIG. 6 is a view showing another program table information when at least two video streams are transmitted through the single virtual channel, which shows the program table information which may be included in the VCT. The VCT includes a service location descriptor. The service location descriptor can parse information indicating whether at least two video streams are included in the single virtual channel. In the example of FIG. 6, if the main_stream_flag is 1, only one video stream is included in the single virtual channel and, if the main_stream_flag is 0, at least two video streams are included in the single virtual channel. The VCT indicates that at least two video streams are included in the virtual channel, and the PMT can parse at least two video stream included in the virtual channel.

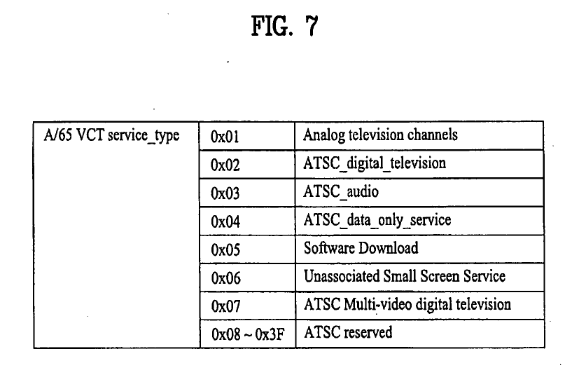

FIG. 7 is a view showing a service type according to an ATSC broadcasting system. In FIG. 7, if an identifier is 0x01, it is indicated that the stream service type is analog television channels and, if the identifier is 0x02, it is indicated that the service type is ATSC_digital_television. In the example shown in FIG. 7, 0x07 may be allocated as an identifier of the service type in which at least two video streams are included in the single virtual channel. Identifiers 0x08 to 0x3F indicate reserved areas. If a new service type is received, an old apparatus for receiving a broadcasting signal cannot receive a new type service. Thus, backward compatibility may be ensured.

Meanwhile, as another example of the information indicating whether at least two video streams are included in the single virtual channel, the stream type of the supplementary video stream may be transmitted as a separate stream type. For example, in the ATSC system, in the main video stream and the supplementary video stream included in the virtual channel, the service type of 0x08A may be used in the supplementary video stream. If a new stream type is received, an old apparatus for receiving a broadcasting signal cannot receive a service having the new stream type. Thus, backward compatibility may be ensured. The service types shown in FIG. 7 can be parsed from the program table information such as the VCT.

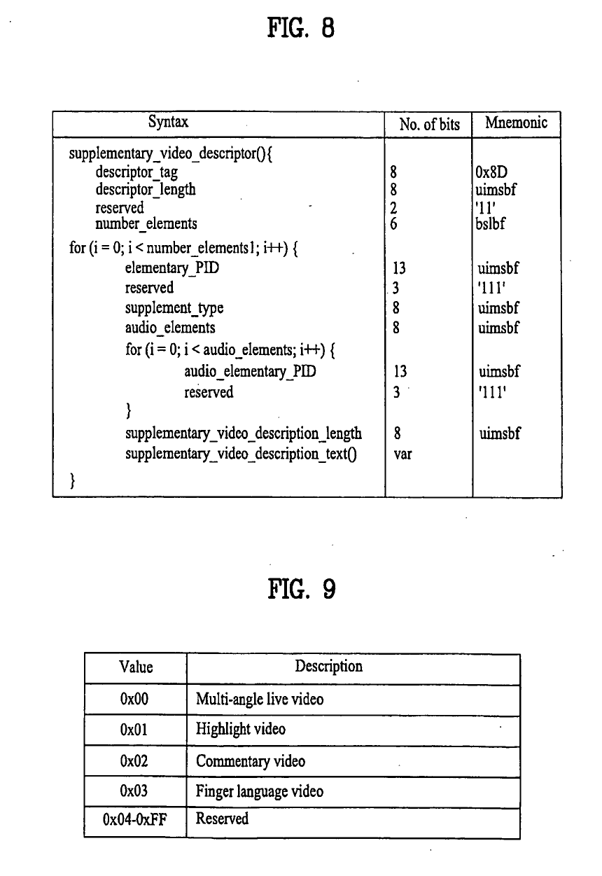

FIG. 8 is a view showing a syntax for parsing information about the supplementary video stream when the supplementary video stream is included in the single virtual channel in addition to a main video stream. For example, information according to the descriptor shown in FIG. 8 may be included in the program table information such as the VCT and may be transmitted. Hereinafter, the descriptor which can parse the information about the supplementary video stream is called supplementary_video_descriptor.

The example shown in FIG. 8 may include descriptor_tag which is a descriptor identifier and descriptor_length which is length information. The supplementary_video_descriptor may include the number of program elements for the supplementary video stream (number_elements). The supplementary_video_descriptor can parse the elementary_PID for each element. A field “supplement_type” indicates which type of image the supplementary video stream is. Information which can be parsed by supplement_type is shown in FIG. 9.

The supplementary video stream may be displayed in synchronization with the separate audio stream which is separated from the main video stream. If the separate audio stream is included in the supplementary video stream, supplementary_video_descriptor may include information about audio elements. FIG. 8 shows information about the audio element such as audio_element_PID. Supplementary_video_description_text( ) indicates detailed description information for the supplementary video stream and may follow multiple_string_structure( ) according to the ATSC system. Supplementary_video_description_length( ) indicates the length of the detailed description information.

FIG. 9 is a view showing detailed information about the supplementary video stream. The detailed information about the supplementary video stream may indicate which type of image the supplementary video stream is. In FIG. 9, if the detailed information about the supplementary video stream is 0x00, it is indicated that the supplementary video stream is a multi-angle video stream. In the example shown in FIG. 9, if the detailed information about the supplementary video stream is 0x01, it is indicated that the supplementary video stream is a stream including a highlight image of the main video stream. If the detailed information about the supplementary video stream is 0x02, it is indicated that the supplementary video stream is a stream which can be displayed in the PIP form on a screen for describing the main video stream, for example, a commentary screen or a relay screen. Accordingly, at the time of a broadcast of sports, the commentary screen can be viewed according to the selection of a user.

As another example, the detailed information about the supplementary video stream is 0x03, it is indicated that the supplementary video stream is a separate video stream provided to a physically handicapped person. For example, a video stream including a finger language of a corresponding program, which is separated from the main video stream, may be transmitted/received for a hearing-impaired person. If the detailed information of the supplementary video stream is transmitted, the user can obtain the detailed information and selectively reproduce the supplementary video stream.

If the separate video/audio stream is desired to be reproduced, a receiver can control the stream indicated by the supplementary video stream to be displayed on the screen.

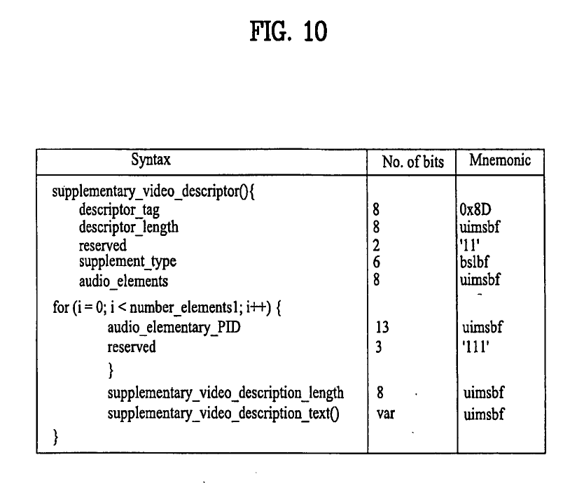

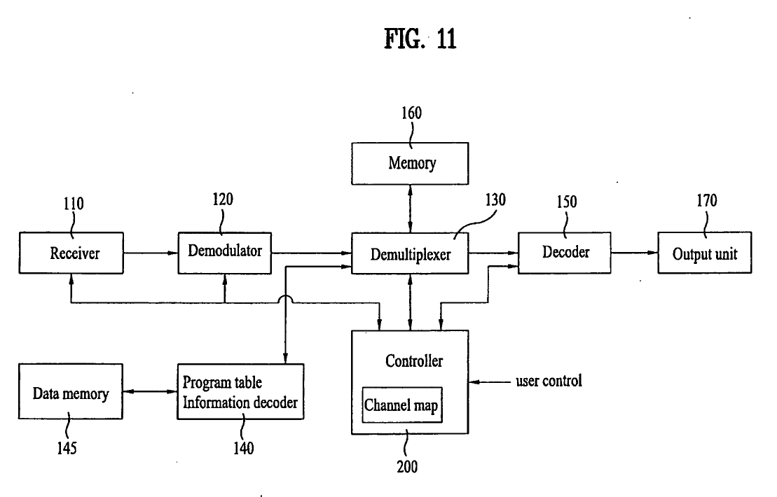

FIG. 10 is a view showing another syntax for parsing the information about the supplementary video stream. FIG. 10 shows the syntax which can parse the information about the supplementary video stream through the PMT. Supplementary_video_descriptor can be included in an ES loop of the PMT so as to be parsed by the stream descriptor.

In this case, supplementary_video_descriptor is the stream descriptor included in the program descriptor, which can parse the stream included in each program. If at least two video streams are included in the single virtual channel, information indicating which type of stream the supplementary video stream is may be included. If the supplementary video stream includes the audio stream which is separated from the main video stream, the separated audio stream can be parsed (audio-element loop). In the supplementary_video_descriptor, supplementary_video_description_text( ) includes the detailed description information of the supplementary video stream as described with reference to FIG. 9 and supplementary_video_description_length( ) indicates the length of the detailed description information.

FIG. 11 is a view showing an example of an apparatus for receiving a broadcasting signal. The example of the apparatus for receiving the broadcasting signal will be described with reference to FIG. 11. FIG. 11 shows an example of the apparatus for receiving the broadcasting signal in which at least two video streams are included in the single virtual channel. The example of FIG. 11 may include a receiver 110, a demodulator 120, a demultiplexer 130, a program table information decoder 140, a decoder 150, a memory 160, an output unit 170 and a controller 200.

The receiver 110 receives the broadcasting signal, in which at least two video streams are included in the single virtual channel, and outputs the broadcasting signal of a channel according to a control signal output from the controller 200 in the received broadcasting signal.

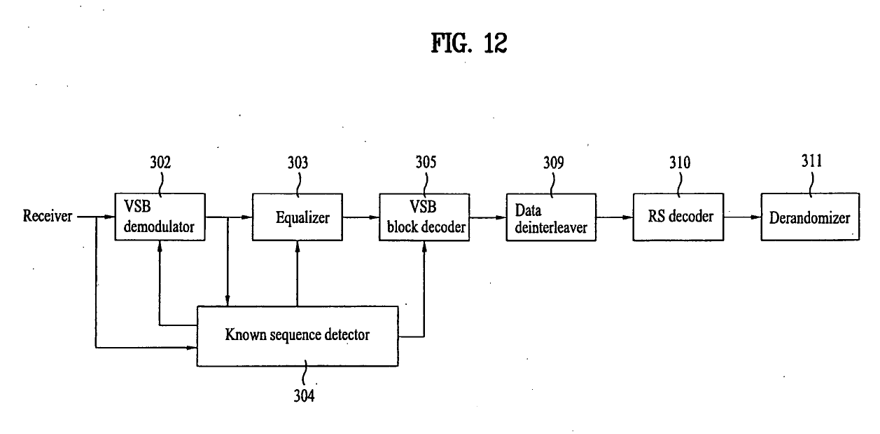

The demodulator 120 may demodulate the received signal and output the demodulated signal. For example, the demodulator 120 may demodulate the broadcasting signal according to the ATSC broadcasting system. FIG. 12 is a view showing an example of demodulating the broadcasting signal according to the ATSC broadcasting system.

The demultiplexer 130 may demultiplex the program table information such as PSI/PSIP, the audio stream and the video stream in the signal demodulated by the demodulator and output the demultiplexed signals.

The program table information decoder 140 may decode the program table information demultiplexed by the demultiplexer 130 and temporarily store the decoded table information. The program table information decoder 140 may parse the table information indicating that at least two video streams are included in the single virtual channel, that is, the PMT or the VCT, extract the identifier, and output the identifier to the decoder 150 or the controller 200.

The decoder 150 may decode the audio stream or the video stream demultiplexed by the demultiplexer 130. The decoder 150 may receive the information indicating that at least two video streams are included in the single virtual channel from the program table information decoder 140 or the controller 200, decode the video streams, and output the decoded video streams.

The memory 160 may store the video stream and the audio stream output from the demultiplexer 130. The output unit 170 output the audio signal decoded by the decoder 150 as an audible signal. The output unit 170 can display a video image output from the decoder 150 on the screen. If at least two video streams are included in the single virtual channel, the output unit 170 may simultaneously output the video images according to the two video streams. The images displayed by the output unit 170 may be multi-view video images or images in which the image according to the supplementary video stream is output together with the image according to the main video stream in the PIP or screen division form. The output unit 170 includes an on-screen display (OSD) for outputting a graphic signal displayed on a display.

The controller 200 may transmit/receive the control signal to/from an interface for receiving the control signal from the user. The controller 200 may control the blocks included in the apparatus for receiving the broadcasting signal and output the broadcasting signal according to the control signal of the user. The controller 200 may store channel information parsed by the program table information decoder 140 to a channel map and control the receiver 110 to output a virtual channel selected by the user under the control of the user.

The controller 200 may receive the information indicating that at least two video streams are included in the single virtual channel from the program table information decoder 140 and control the decoder 150 such that the output unit 170 outputs the supplementary video stream if the user selects the images according to the two video streams or the image according to the supplementary video stream. The controller 200 may output the decoded video/audio stream such that the supplementary video stream is output according to the information about the supplementary video stream/supplementary audio stream output from the program table information decoder 140.

The program table information decoder 140 may decode the program information according to the PSI or the PSIP. The broadcasting data for a data broadcast may be of a packetized elementary stream (PES) type or a section type. That is, the data for the data broadcast includes PES type data or section type data.

For example, the data for the data broadcast is included in a digital storage media-command and control (DSM-CC) section and the DSM-CC section may be composed of a TS packet in the unit of 188 bytes. The identifier of the TS packet included in the DSM-CC section is included in program table information which is data service table. If the DST is transmitted, 0x95 is allocated as the stream_type field value in the service location descriptor of the PMT or the VCT. The data for the data broadcast may be transmitted by a data carousel method.

In order to process the data for the data broadcast, the demultiplexer 130 may perform section filtering under the control of the program table information decoder 140, discard a repetition section, and output a non-repetition section to the program table information decoder 140. The program table information decoder 140 can check whether the data for the data broadcast is included in the broadcasting signal, according to the PID of the VCT. The PID of the VCT may be set in the MGT or may have a fixed value.

The demultiplexer 130 may output only an application information table (AIT) to the program table information decoder 140 through the section filtering. The AIT includes information about an application executed by the apparatus for receiving the broadcasting signal, for a data service.

The AIT may include information about an application, for example, the name of the application, the version of the application, the priority of the application, the ID of the application, the status of the application (auto-start, user operability, kill or the like), the type of the application (Java or HTML), the class of the application, the position of the stream including a data file, the base directory of the application, and the position of the icon of the application. Accordingly, the information necessary for executing the application may be stored in a data memory 145 using such information.

The application executed by the controller 200 may be received together with broadcasting data and may be updated. A data broadcasting application manager which is executed in order to execute the application by the controller 200 may include a platform for executing an application program. The platform may be, for example, a Java virtual machine for executing a Java program.

If a data information service is a traffic information service, the apparatus for receiving the broadcasting signal can provide the user with the service through at least one of characters, voice, graphic, a still image or a moving image, even when an electronic map or a global positioning system (GPS) is not mounted therein. If the apparatus for receiving the broadcasting signal includes the GPS module, the GPS module can extract current positional information (longitude, latitude and altitude) and execute the data broadcasting application. The data memory 145 of the apparatus for receiving the broadcasting signal may store the electronic map including information about links and nodes and a variety of graphic information.

FIG. 12 shows an example of the demodulator shown in FIG. 11. The example of the demodulator will be described with reference to FIG. 12. The demodulator performs carrier synchronization recovery, frame synchronization recovery and channel equalization so as to improve reception capability. The example of FIG. 12 includes a VSB demodulator 302, an equalizer 303, a known sequence detector 304, a VSB block decoder 305, a data deinterleaver 309, an RS decoder 310 and a derandomizer 311.

The VSB demodulator 302 and the known sequence detector 704 receive an intermediate frequency (IF) signal, which is obtained by tuning the frequency of a signal, from the receiver 110. The VSB demodulator 302 performs carrier recovery and timing recovery with respect to the received IF signal to convert the received IF signal into a baseband signal in consideration of the VSB method and outputs the baseband signal to the equalizer 303 and the known sequence detector 704. The equalizer 303 outputs a signal of which distortion of a channel included in the demodulated signal is compensated for. In this case, the known sequence detector 704 detects the position of known sequence, which is inserted in a transmitter, from input/output data of the VSB demodulator 302, that is, data before or after performing the VSB demodulation. The known sequence detector 704 outputs positional information and the symbol sequence of the known sequence generated at the position to the VSB demodulator 302 and the equalizer 303.

The VSB demodulator 302 can improve demodulation capability using the symbol sequence of the known sequence at the time of the timing recovery or the carrier recovery and the equalizer 303 can improve equalization capability using the known sequence.

The VSB block decoder 305 performs trellis decoding with respect to the data received from the equalizer 303 and outputs the decoded data. The data group decoded by the VSB block decoder 305 is input to the data deinterleaver 309. The VSB block decoder 305 performs viterbi decoding with respect to the received data and outputs a hard decision value or a result of hard-deciding a soft decision value.

The data deinterleaver 309 deinterleaves the data output from the VSB block decoder 305 as an inverse process of a data interleaver of the transmitter and outputs the deinterleaved data to the RS decoder 310. The RS decoder 310 performs systematic RS decoding with respect to the deinterleaved data and outputs the decoded data to the derandomizer 311. The derandomizer 311 receives the output of the RS decoder 310, generates the same pseudo random byte as a randomizer of the transmitter, performs a bitwise exclusive OR (XOR) operation, inserts an MPEG synchronization byte in front of every packet, and outputs a data packet in the unit of 188 bytes.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A method for transmitting a broadcasting signal, the method comprising:
generating program table information including an identifier for identifying a plurality of video streams included in a single virtual channel;
multiplexing the generated program table information and the plurality of video streams; and
transmitting the multiplexed program table information and video streams.

2. The method according to claim 1, wherein the program table information includes an identifier flag for identifying the plurality of video streams.

3. The method according to claim 2, wherein the virtual channel has a service type value indicating that the plurality of video streams are included.

4. The method according to claim 1, wherein the program table information includes at least one of information indicating that a first video stream among the plurality of video streams is a stream configuring a multi-view image of a second video stream or information indicating the first video stream is a stream for a highlight image of the second video stream, information indicating that the first video stream is a stream for a commentary image describing the second video stream and information indicating that the first video stream is a stream for a finger-language image of the second video stream.

5. The method according to claim 1, wherein the program table information is a program map table (PMT).

6. The method according to claim 1, wherein the program table information is a virtual channel table (VCT).

7. A method for receiving a broadcasting signal, the method comprising:
receiving a broadcasting signal in which a plurality of video streams included in a single virtual channel and program table information including information for identifying the plurality of video streams are multiplexed;
parsing the video streams using the received program table information and obtaining the video streams; and
decoding and outputting at least one video stream of the obtained video streams.

8. The method according to claim 7, wherein the program table information includes an identifier flag for distinguishing the plurality of video streams.

9. The method according to claim 8, wherein the virtual channel has a service type value indicating that the plurality of video streams are included.

10. The method according to claim 7, wherein the program table information can describe a supplementary video stream among the plurality of video streams and an audio stream related to the supplementary video stream.

11. The method according to claim 7, wherein the program table information is a program map table (PMT).

12. The method according to claim 7, wherein the program table information is a virtual channel table (VCT).

13. The method according to claim 7, wherein the program table information includes information indicating which type of a video stream a supplementary video stream among the plurality of video streams is.

14. The method according to claim 13, wherein the information indicating which type of the video stream the supplementary video stream is includes at least one of information indicating that the supplementary video stream is a stream for a multi-view image of a main video of the single virtual channel, information indicating that the supplementary video stream is a stream for a highlight image of the main video, information indicating that the supplementary video stream is a stream for a commentary image describing the main video, and information indicating that the supplementary video stream is a stream for a finger-language image of the main video.

15. The method according to claim 7, wherein the, program table information includes at least one of a packet identifier (PID) of an audio stream corresponding to the supplementary video stream and detailed description information of the supplementary video stream.

16. An apparatus for receiving a broadcasting signal, the apparatus comprising:
a receiver configured to receive a broadcasting signal;
a demodulator configured to demodulate the received broadcasting signal;
a demultiplexer configured to demultiplex a plurality of video streams included in a single virtual channel and program table information in the broadcasting signal demodulated by the demodulator;
a program table information decoder configured to decode an identifier for identifying the plurality of video streams from the single virtual channel of the broadcasting signal in the program table information demultiplexed by the demultiplexer;
a decoder configured to decode the plurality of video streams according to the identifier decoded by the program table information decoder; and
an output unit configured to output the video stream output from the decoder.

17. The apparatus according to claim 16, wherein the program table information is one of a program map table (PMT) and a virtual channel table (VCT).

18. The apparatus according to claim 16, wherein the program table information includes information indicating which type of a video stream a supplementary video stream of the video streams of the virtual channel is.

19. The apparatus according to claim 18, wherein the information indicating which type of the video stream the supplementary video stream is includes at least one of information indicating that the supplementary video stream of the single virtual channel is a stream for a multi-view image of a main video of the single virtual channel, information indicating that the supplementary video stream of the single virtual channel is a stream for a highlight image of the main video, information indicating that the supplementary video stream is a stream for a commentary image describing the main video, and information indicating that the supplementary video stream is a stream for a finger-language image of the main video.

20. The apparatus according to claim 16, wherein the program table information includes at least one of a packet identifier (PID) of an audio stream corresponding to the supplementary video stream and detailed description information of the supplementary video stream.
